(19) United States
(12) Patent Application Publication
(10) Pub. No.: US 2011/0279224 A1
(43) Pub. Date: Nov. 17, 2011

(54) REMOTE CONTROL METHOD AND APPARATUS USING SMARTPHONE

(75) Inventor: YOUNG KYU JANG, SEOUL (KR)

(73) Assignee: KOREAFIRSTEC CO., LTD., SEOUL (KR)

(21) Appl. No.: 13/108,121

(22) Filed: May 16, 2011

(30) Foreign Application Priority Data
May 14, 2010 (KR) 10-2009-0045557
Oct. 1, 2010 (KR) 10-2010-0095743

(51) Int. Cl. G05B 19/02

(52) U.S. Cl. 340/4.31; 340/4.3

(57) ABSTRACT

A remote control method using a smartphone is disclosed. In the method, a smartphone adapted for mobility interworks with a stationary computer to overcome performance limitations thereof and to provide more advanced services. The method, for remotely controlling a stationary computer using a smartphone, includes: accepting user manipulation and sensing results; generating a control signal for an application running on the stationary computer through filtering and optimizing the accepted results; transmitting the control signal to the stationary computer; applying the control signal to the application; and receiving a response signal of the application from the stationary computer. Hence, a smartphone interworks with a stationary computer through a wired or wireless network, and the user of the smartphone may utilize various types of applications without performance and resource limitations by transmitting control signals corresponding to user manipulation or sensing results to the stationary computer executing actual applications.

### TECHNICAL FIELD

The present invention relates to remote control using a smartphone and, more particularly, to a remote control method and apparatus using a smartphone wherein a smartphone adapted for mobility interworks with a stationary computer to overcome performance limitations thereof and to provide more advanced services.

### BACKGROUND ART

With rapid advances in computer, electronics and communication technology, stationary computers have evolved into handheld mobile devices, which may not only provide mobile communication services through wireless networks but also act as computing terminals. For example, beyond stand-alone devices, smartphones may support both communication and computing services.

A smartphone employs a system similar to an operating system (OS) of a standard computer, and may support voice and data communication and other functions such as multimedia content playback and application execution.

However, even a powerful smartphone with a high-performance chipset and a large memory capacity has size limitations restricting mountable resources. This makes it difficult to reproduce multimedia content and execute applications on the smartphone. Hence, to reproduce various types of multimedia content and execute various applications on smartphones, applications developed for stationary computers may have to be reduced in functionality and ported to smartphones.

### DETAILED DESCRIPTION OF THE INVENTION

The present invention has been made in view of the above problems, and the present invention provides a remote control method and apparatus using a smartphone wherein the smartphone and a stationary computer interwork through a network so as to remotely control the stationary computer and execute various types of applications without performance restriction.

An aspect of the present invention is to provide a method for remotely controlling a stationary computer using a smartphone, including: accepting manipulation results of a user and sensing results of sensors; generating a control signal for an application running on the stationary computer through filtering and optimizing the accepted results; transmitting the control signal to the stationary computer; and receiving a response signal of the application from the stationary computer.

The method may further includes: connecting to, before accepting user manipulation results, the stationary computer via a wired or wireless network; and executing a sub-application interworking with the application.

Generating a control signal for an application may include: extracting a portion of the user manipulation results and sensing results related to the application; and generating the control signal by converting the extracted portion into a signal for transmission through compression.

The method may further include: analyzing, after receiving a response signal, the response signal; and reproducing an application screen, sound and vibration according to the analysis results.

The sensing results may be related to sound and brightness around the user, and location and placement state of the smartphone.

The application may be an application for authoring object-based content by providing supplementary information to an object appearing in played back content of moving images or photographs; the user may be an author who authors object-based content on the basis of regular image content by remotely controlling the authoring application using the smartphone; the control signal may be a signal that is generated by the smartphone for controlling an object-based content authoring process according to user input, and the response signal may be a signal that is generated by the authoring application in progress and is sent to the smartphone.

The application may be an application that plays back object-based content and provides supplementary information of an object appearing in the object-based content; the user may enjoy the object-based content and view supplementary information of an object appearing in the object-based content by remotely controlling the application using the smartphone; the control signal may be a signal that is generated by the smartphone according to user inputs to control a process of playback of the object-based content and providing supplementary information; and the response signal may be a signal that is generated by the application in a process of playing back the object-based content and providing supplementary information and is sent to the smartphone.

Another aspect of the present invention is to provide a method for application execution on a stationary computer according to remote control of a smartphone, including: receiving a control signal for an application in execution from the smartphone and analyzing the received control signal; determining an event corresponding to the analyzed control signal and applying the event to a process of the application; generating a response signal by converting and optimizing output results of the application process; and transmitting the response signal to the smartphone.

The method may further includes: receiving, before receiving a control signal, a connection request from the smartphone via a wired or wireless network; and executing a main application interworking with the application.

Generating a response signal may include: processing output results of the application into a form reproducible by the smartphone with reference to existing setting information; and generating the response signal by converting the processed output results into a signal for transmission through compression.

The setting information may include data related to display resolution and video codecs of the smartphone.

The application may be an application for authoring object-based content by providing supplementary information to an object appearing in played back content of moving images or photographs; the control signal may be a signal that is generated by the smartphone for controlling an object-based content authoring process according to user input; and the response signal may be a signal that is generated by the authoring application in progress and is sent to the smartphone.

The application may be an application that plays back object-based content and provides supplementary information of an object appearing in the object-based content; the control signal may be a signal that is generated by the smartphone according to user inputs to control a process of playback of the object-based content and providing supplementary information; and the response signal may be a signal that is generated by the application in a process of playback of the object-based content and providing supplementary information and is sent to the smartphone.

Still another aspect of the present invention is to provide a remote control apparatus including a smartphone and a stationary computer, wherein the smartphone includes: an input/output unit accepting manipulation results of a user and sensing results of sensors; a remote control unit generating a control signal for an application running on the stationary computer through filtering and optimizing the accepted results; and a terminal transceiver unit transmitting the control signal to the stationary computer and receiving a response signal of the application from the stationary computer, and wherein the stationary computer includes: a remote input/output unit analyzing the control signal and generating the response signal by converting and optimizing output results of the application; an application activation unit determining an event corresponding to the control signal analyzed by the remote input/output unit, applying the event to a process of the application, and providing output results of the application to the remote input/output unit; and a computer transceiver unit receiving the control signal and transmitting the response signal to the smartphone.

The input/output unit may include: an input module having at least one of a qwerty keypad, touchscreen, optical track mouse, camera module, microphone module, GPS module, tilt sensor and ambient light sensor; and an output module having at least one of a display module, speaker module and vibration module.

The remote control unit may include: a filtering and optimization module extracting a portion of the manipulation results and sensing results related to the application and generating the control signal by converting the extracted portion into a signal for transmission through compression; and a response analysis module analyzing the response signal and providing the analysis results to the input/output unit.

The remote input/output unit may include: a device interworking module analyzing the control signal and generating the response signal by converting and optimizing output results of the application; and a function setting module providing setting information containing data related to display resolution and video codecs of the smartphone to the device interworking module generating the response signal.

The application activation unit may include: a requesting module determining an event for keys, coordinates or sensing results corresponding to the control signal analyzed by the remote input/output unit and applying the event to a process of the application; and an executing module outputting results of the application process in progress.

The application activation unit may include an object-based content authoring tool that authors object-based content according to remote control of the user utilizing the smartphone.

The application activation unit may include an object-based content player that plays back object-based content according to remote control of the user utilizing the smartphone.

In a feature of the present invention, a smartphone and a stationary computer interwork through a wired or wireless network. Application control signals corresponding to user manipulation or sensing results are fed through the smartphone to the stationary computer to execute various types of applications without performance limitation.

### BRIEF DESCRIPTION OF THE DRAWINGS

The objects, features and advantages of the present invention will be more apparent from the following detailed description in conjunction with the accompanying drawings, in which:

FIG. 1 is a block diagram of a remote control apparatus using a smartphone according to an embodiment of the present invention;

FIG. 2 is a block diagram of the smartphone in the apparatus of FIG. 1;

FIG. 3 is a block diagram of a stationary computer in the apparatus of FIG. 1;

FIG. 4 is a flowchart of a remote control method depicted with the focus on the smartphone according to another embodiment of the present invention;

FIG. 5 is a flowchart of the remote control method depicted with the focus on the stationary computer;

FIG. 6 is a sequence diagram illustrating overall signal flows between modules of the remote control apparatus carrying out the remote control method;

FIG. 7 illustrates an example of realization of the remote control method and apparatus using a smartphone;

FIG. 8 illustrates the configuration of an object-based content application running on the stationary computer;

FIG. 9 is a flowchart of a procedure for authoring object-based content on the stationary computer according to remote control using a smartphone;

FIG. 10 is a sequence diagram illustrating signal flows between components carrying out the procedure for authoring object-based content in FIG. 9;

FIG. 11 is a flowchart of a procedure for utilizing object-based content on the stationary computer according to remote control using a smartphone;

FIG. 12 is a sequence diagram illustrating signal flows between components carrying out the procedure for utilizing object-based content of FIG. 11; and

FIGS. 13 to 15 are screen representations depicting operation of an object-based content providing apparatus for a mobile terminal.

### MODE FOR THE INVENTION

Hereinafter, a remote control method and apparatus using a smartphone according to exemplary embodiments of the present invention will be described with reference to the accompanying drawings.

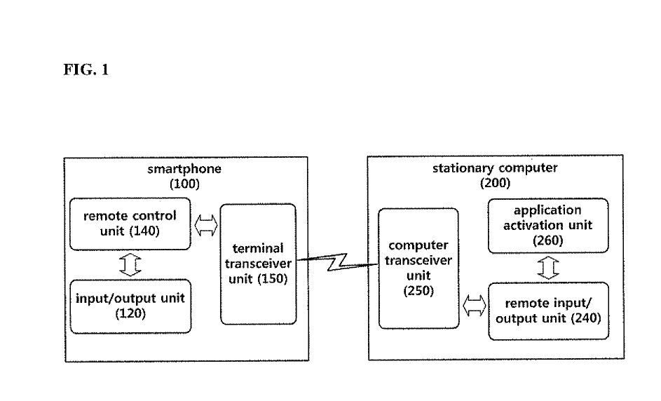

FIG. 1 is a block diagram of a remote control apparatus using a smartphone according to an embodiment of the present invention.

Referring to FIG. 1, the remote control apparatus is composed of a smartphone 100 for accepting user input and displaying corresponding results, and a stationary computer 200 for executing an application and providing application results according to control of the smartphone 100.

The smartphone 100 includes an input/output unit 120 that accepts signals generated by user manipulation and sensors and displays outputs received from an application executed on the stationary computer 200, a remote control unit 140 that processes input signals from the input/output unit 120 through filtering and optimization to supply application control signals to the stationary computer 200 in order to achieve interworking with the stationary computer 200 and control an executed application, and a terminal transceiver unit 150 that connects to the stationary computer 200 through a wired or wireless network to send control signals from the remote control unit 140 to the stationary computer 200 and receive response signals therefrom. Here, in the smartphone 100, the remote control unit 140 may be implemented as a sub-application that interworks with a main application being executed on the stationary computer 200.

The stationary computer 200 includes a computer transceiver unit 250 that connects to the smartphone 100 to receive control signals and send response signals, a remote input/output unit 240 that processes control signals received by the computer transceiver unit 250 into control signals applicable to the executed application, and an application activation unit 260 that applies control signals processed by the remote input/output unit 240 to the corresponding application for execution and supplies execution results to the smartphone 100 through the remote input/output unit 240.

Here, in the stationary computer 200, the remote input/output unit 240 and the application activation unit 260 may be implemented as a main application that interworks with a sub-application executed on the smartphone 100.

As described above, in the remote control apparatus of the present invention, applications are executed through interworking between a smartphone and a stationary computer. Next, a detailed description is given of configurations of the smartphone and the stationary computer with reference to the drawings.

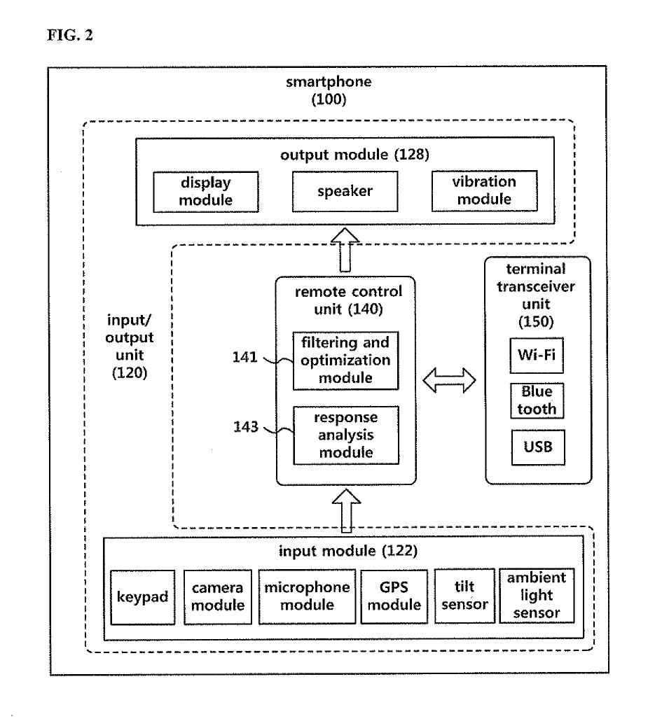

FIG. 2 is a block diagram of the smartphone 100 in the remote control apparatus of FIG. 1.

As shown in FIG. 2, the smartphone 100 includes an input/output unit 120, a remote control unit 140 and a terminal transceiver unit 150.

More specifically, the input/output unit 120 includes an input module 122 that has a keypad and other sensors to directly or indirectly accept user input, and an output module 128 that has a display module and other output means to output application results from the stationary computer.

The input module 122 provides an interface that enables the user to manipulate an application installed in the stationary computer, and may indicate generic functions of input means such as a qwerty keypad, a touchscreen and an optical track mouse. In addition to these direct manipulation devices, the input module 122 may further include a camera module to photograph surroundings of the smartphone, a microphone module to detect sound, a GPS module to determine coordinates of the smartphone, and various types of sensors such as a tilt sensor detecting orientation of the smartphone and an ambient light sensor sensing intensity of ambient light. The input module 122 forwards entered or detected inputs to the remote control unit 140.

The output module 128 reproduces application results from the stationary computer, and includes a display module to display an application handling screen. The output module 128 may further include a speaker and a vibration module to reproduce sound or haptic outputs of an executed application. The application handling screen and other outputs has already been processed in a form suitable for the smartphone, where the remote control unit 140 analyzes received response signals to output the same through the output module 128.

The remote control unit 140 processes received signals from the input/output unit 120 through filtering and optimization and analyzes signals from the stationary computer to achieve interworking between the smartphone and stationary computer. The remote control unit 140 performs necessary conversion to associate user and sensed inputs from the input/output unit 120 with response signals from target applications on the stationary computer.

To achieve this, the remote control unit 140 may include a filtering and optimization module 141 and a response analysis module 143. The filtering and optimization module 141 filters user inputs and sensing results continuously obtained by the input module 122 to extract application related signals, and optimizes (or compresses) the application related signals for network transmission and provides the same to the stationary computer as application control signals. The response analysis module 143 analyzes response signals from the stationary computer and provides the same to the output module 128 as application results.

The terminal transceiver unit 150 connects to the stationary computer through a wired or wireless network, and sends controls signals generated by the remote control unit 140 to the stationary computer and receives response signals of executed applications. The terminal transceiver unit 150 may connect to the stationary computer through a Wi-Fi, Bluetooth or USB connection.

The smartphone having the above configuration generates application control signals corresponding to application control inputs and sends the application control signals to the stationary computer, and receives application results from the stationary computer and reproduces and displays the received application results.

Next, a description is given of the stationary computer with reference to the drawings.

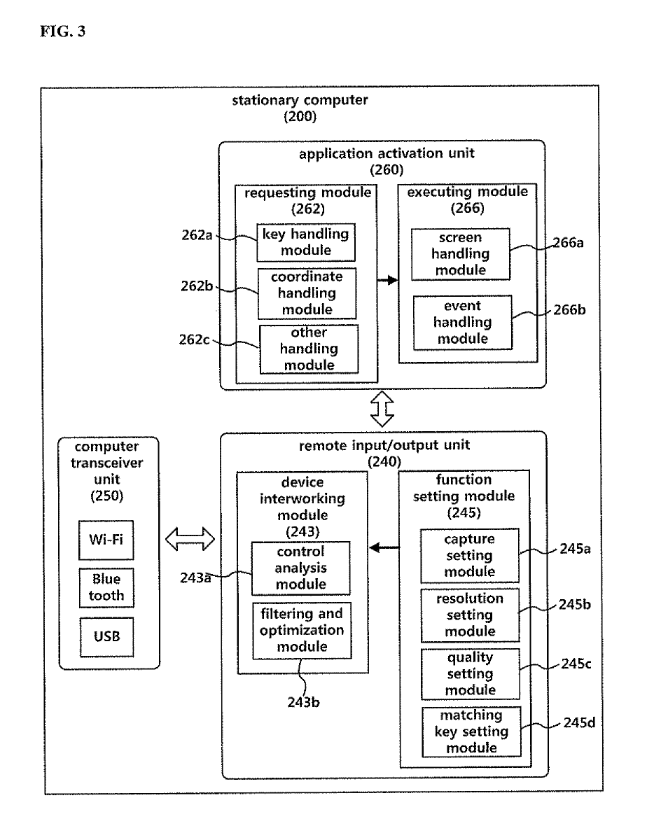

FIG. 3 is a block diagram of the stationary computer in the remote control apparatus of FIG. 1.

As shown in FIG. 3, the stationary computer includes a computer transceiver unit 250, a remote input/output unit 240 and an application activation unit 260.

More specifically, the computer transceiver unit 250 connects to the smartphone through a wired or wireless network and receives application control signals from the smartphone. The computer transceiver unit 250 corresponds to the network connection scheme of the smartphone.

The remote input/output unit 240 includes a device interworking module 243 that analyzes control signals received by the computer transceiver unit 250 and provides the analyzed control signals to the application activation unit 260, and generates response signals corresponding to application results from the application activation unit 260 and provides the response signals to the smartphone via the computer transceiver unit 250. The remote input/output unit 240 further includes a function setting module 245 that provides setting information defining detailed settings to the device interworking module 243 for signal generation or conversion.

The device interworking module 243 includes a control analysis module 243a that analyzes control signals from the smartphone and provides the analyzed control signals to the application activation unit 260, and a filtering and optimization module 243b that generates response signals corresponding to application results.

The control analysis module 243a analyzes control signals corresponding to user manipulation of or sensing results from the smartphone to process the control signals in a form applicable to the target application, and is associated with interface functions of the stationary computer. The control signals may include various types of signals generated by a qwerty keypad, camera module, microphone module and GPS module, and the control analysis module 243a processes such control signals and provides the application activation unit 260 with the processed control signals in a form applicable to executed applications.

The filtering and optimization module 243b filters results of an application executed by the application activation unit 260 to extract portions of the results to be sent to the smartphone, and optimizes the extracted results through, for example, compression for network transmission and provides the optimized results to the smartphone as response signals corresponding to application results.

The function setting module 245 provides the filtering and optimization module 243b with detailed reference information for processing application results. The function setting module 245 may include a capture setting module 245a enabling and disabling a screen capture function that reproduces captured application screens on the smartphone with visual or sound effects, a resolution setting module 245b for setting the resolution of video images captured by the capture setting module 245a, a quality setting module 245c for setting qualities such as the number of frames, frequency bands and volumes of captured video or audio, and a matching key setting module 245d for setting key combinations corresponding to function keys involving Crtl, Alt or Esc incompatible with the smartphone.

The application activation unit 260 includes a requesting module 262 for applying analyzed control signals to a target application, and an executing module 266 for processing outputs of an application executed by the requesting module 262.

The requesting module 262 generates application events so that a target application is executed according to analyzed control signals (not an interface of the stationary computer). To achieve this, the requesting module 262 may include a key handling module 262a that generates key events based on the interface of the stationary computer according to control signals and applies the key events to the target application process, a coordinate handling module 262b that generates mouse events corresponding to coordinates of touch points on the touchscreen of the smartphone and applies the mouse events to the target application process, and an other handling module 262c that generates special events corresponding to sound and light inputs and applies the special events to the target application process.

The executing module 266 processes output signals of the target application process executed according to various events applied by the requesting module 262. To achieve this, the executing module 266 may include a screen handling module 266a that generates signals carrying images generated by the target application process in execution, and an event handling module 266b that generates signals carrying events related to sound generation, data storage, and activation of an attached device such as a printer (other than screen images).

As described above, the application activation unit executes a target application according to control signals and provides execution results to the remote input/output unit, which then converts the execution results and sends the converted execution results to the smartphone.

Hence, the stationary computer interworking with the smartphone executes an application according to control of the smartphone and outputs application results through the smartphone. Next, a remote control method of the present invention is described with the focus on the smartphone in connection with the drawings.

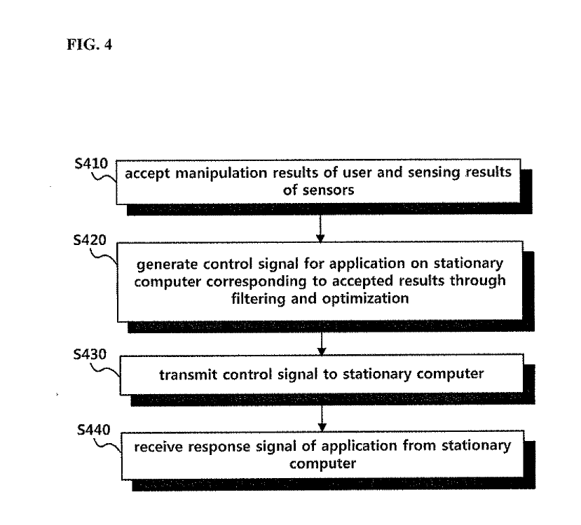

FIG. 4 is a flowchart of a remote control method using a smartphone according to another embodiment of the present invention.

Referring to FIG. 4, as a method for remotely controlling a stationary computer using a smartphone, the remote control method includes: accepting manipulation results of the user and sensing results of sensors (S410); generating control signals for a target application on the stationary computer corresponding to the accepted results through filtering and optimization (S420); transmitting the control signals to the stationary computer (S430); and receiving response signals of the target application from the stationary computer (S440).

To be more specific, at step S410 of accepting manipulation results of the user and sensing results of sensors, manipulation results of the user or sensing results of sensors are entered through the input module of the smartphone. Here, sensing results may include data regarding sound and brightness in the vicinity of the user, and location and placement state of the smartphone. Before step S410, the remote control unit may control the terminal transceiver unit to connect to the stationary computer through a wired or wireless network, and execute a sub-application interworking with a target application.

At step S420 of generating control signals for a target application on the stationary computer corresponding to the accepted results through filtering and optimization, the remote control unit receives the input signals from the input module, extracts application related signals from the input signals, and generates control signals for transmission by filtering and optimizing the application related signals based on compression. The control signals are sent to the stationary computer and used to control execution of the target application, achieving interworking between the smartphone and the stationary computer.

At step S430 of transmitting the control signals to the stationary computer, the terminal transceiver unit 150 sends the control signals generated at step S420 to the stationary computer connected through a wired or wireless network.

At step S440 of receiving response signals of the target application from the stationary computer, the stationary computer executes the target application according to the received control signals and provides response signals corresponding to the application results to the smartphone. The terminal transceiver unit receives the response signals, the response analysis module of the remote control unit analyzes the received response signals, and the output module outputs an application handling screen, sound and vibration according to the analysis results.

The remote control method of the present invention may be applied not only to a stationary computer owned by an individual person but also to a subordinate server acting as a networked resource on a cloud network. That is, when the user of the smartphone activates an installed sub-application, the smartphone is connected to an address of a cloud network indicated by the sub-application and the corresponding cloud server executes the main application associated with the sub-application. Hence, as in the case of the stationary computer described before, the user may utilize an application executed on a cloud server.

Next, the remote control method of the present invention is described with the focus on the stationary computer in connection with the drawings.

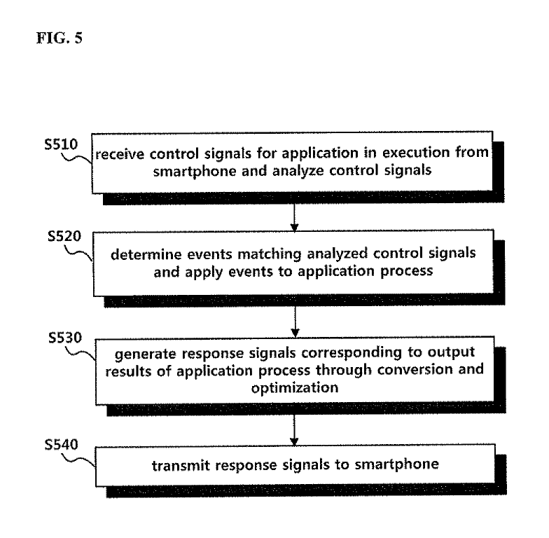

FIG. 5 is a flowchart of the remote control method depicted with the focus on the stationary computer.

Referring to FIG. 5, as a method for remotely controlling a stationary computer using a smartphone, the remote control method includes: receiving control signals for an application in execution from the smartphone and analyzing the control signals (S510); determining input events matching the analyzed control signals and applying the input events to the application process (S520); generating response signals corresponding to the output results of the application process through conversion and optimization (S530); and transmitting the response signals to the smartphone (S540).

More specifically, at step S510 of receiving control signals for an application in execution from the smartphone and analyzing the control signals, the computer transceiver unit of the stationary computer receives application control signals from the smartphone through a wired or wireless network and the remote input/output unit analyzes the received application control signals. Before step S510, the computer transceiver unit may receive a connection request from the smartphone and execute a requested main application for interworking with the smartphone.

In addition, the device interworking module of the remote input/output unit analyzes and processes the control signals in a form applicable to the application executed by the application activation unit. Particularly, the control analysis module extracts qwerty keypad signals and various sensing signals of the smartphone from the analyzed control signals and provides the extracted key and sensing signals to the application activation unit.

At step S520 of determining input events matching the analyzed control signals and applying the input events to the application process, the application activation unit generates input events matching the analyzed control signals and applies the input events to the application process. The requesting module of the application activation unit generates application events based on the interface of the stationary computer according to control signals and applies the generated events to the application process. The key handling module of the requesting module handles key signals related to a qwerty keypad, the coordinate handling module handles signals related to coordinates of touch points and selection on the touchscreen of the smartphone, and the other handling module 262c handles special events corresponding to sound and light inputs.

At step S530 of generating response signals corresponding to the output results of the application process through conversion and optimization, the application activation unit outputs processing results of the application process in progress. In particular, the screen handling module of the executing module generates signals carrying images generated by the application process in execution, and the event handling module generates signals carrying events related to sound generation, data storage, and activation of an attached device such as a printer (other than screen images).

The application outputs are converted into response signals by the filtering and optimization module of the application activation unit. During generation of response signals, the function setting module provides detailed reference information for processing application results; the capture setting module is used to enable and disable a screen capture function that reproduces captured application screens on the smartphone with visual or sound effects; the resolution setting module is used to set the resolution of captured video images; the quality setting module is used to set qualities such as the number of frames, frequency bands and volumes of captured video or audio; and the matching key setting module is used to set key combinations corresponding to function keys incompatible with the smartphone.

With the help of the function setting module, the filtering and optimization module filters results of the executed application to extract portions of the results to be sent to the smartphone, and optimizes the extracted results through compression for network transmission to generate response signals corresponding to application results.

At step S540 of transmitting the response signals to the smartphone, the computer transceiver unit sends the response signals generated by the filtering and optimization module to the smartphone.

According to the steps described above, the remote control method of the present invention may execute a requested application through interworking between the smartphone and the stationary computer and output application results through the smartphone. Next, the remote control method is described in more detail with reference to signal flows between components or modules of the smartphone and the stationary computer.

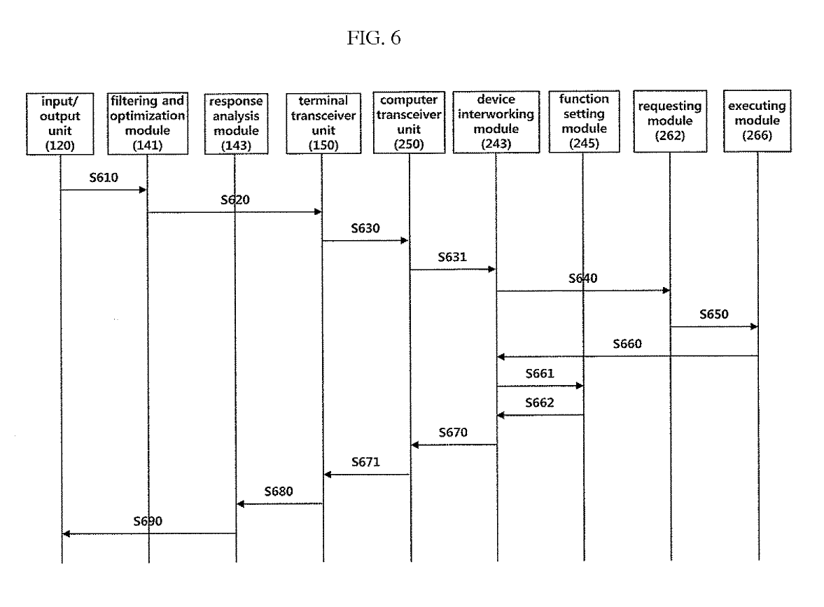

FIG. 6 is a sequence diagram illustrating overall signal flows between modules of the remote control apparatus carrying out the remote control method of the present invention.

Referring to FIG. 6, the input/output unit 120 of the smartphone accepts results of user manipulation and sensing results of sensors and forwards the results to the filtering and optimization module 141 (S610). The filtering and optimization module 141 generates corresponding control signals and forwards the control signals to the terminal transceiver unit 150 (S620). The terminal transceiver unit 150 sends the generated control signals to the stationary computer (S630). The computer transceiver unit 250 of the stationary computer receives the control signals and forwards the control signals to the device interworking module 243 (S631).

The device interworking module 243 analyzes the received control signals to process the control signals into a form applicable to the target application and forwards the processed control signals to the requesting module 262 (S640). The requesting module 262 determines input events corresponding to the control signals and applies the input events to the application process (S650). The executing module 266 executes the application process according to the input events and outputs the application results to the device interworking module 243 (S660).

The device interworking module 243 refers to setting information of the function setting module 245 (S661) and generates response signals corresponding to the application results (S662). The device interworking module 243 forwards the generated response signals to the computer transceiver unit 250 (S670). The computer transceiver unit 250 sends the response signals to the smartphone 100 (S671). The terminal transceiver unit 150 of the smartphone receives the response signals and forwards the response signals to the response analysis module 143 (S680). The response analysis module 143 analyzes the response signals and forwards the analysis results to the input/output unit 120 (S690), and the input/output unit 120 outputs application screens, sound and vibration according to the analysis results.

According to the steps described above, the remote control method of the present invention may execute a requested application through interworking between the smartphone and the stationary computer and output application results through the smartphone.

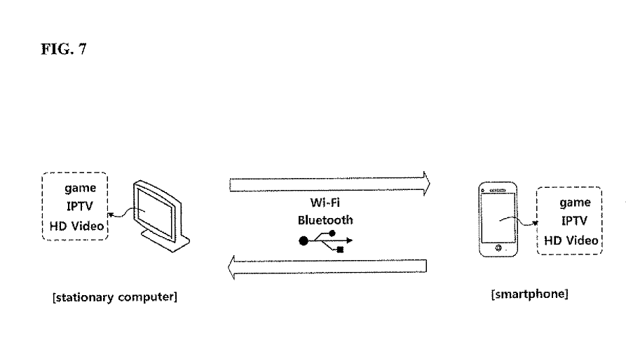

FIG. 7 illustrates an example of realization of the remote control method and apparatus using a smartphone.

As shown in FIG. 7, for applications requiring a large amount of computing resources, such as online games, IPTV broadcasts and high-definition movies, the remote control method of the present invention enables interworking between a stationary computer actually running an application and a portable smartphone controlling application execution via Wi-Fi, Bluetooth and USB connections.

In addition to simple key inputs using a regular keypad, various types of inputs obtained from a camera module, microphone module, GPS module, tilt sensor and ambient light sensor installed in the smartphone may be used for application execution.

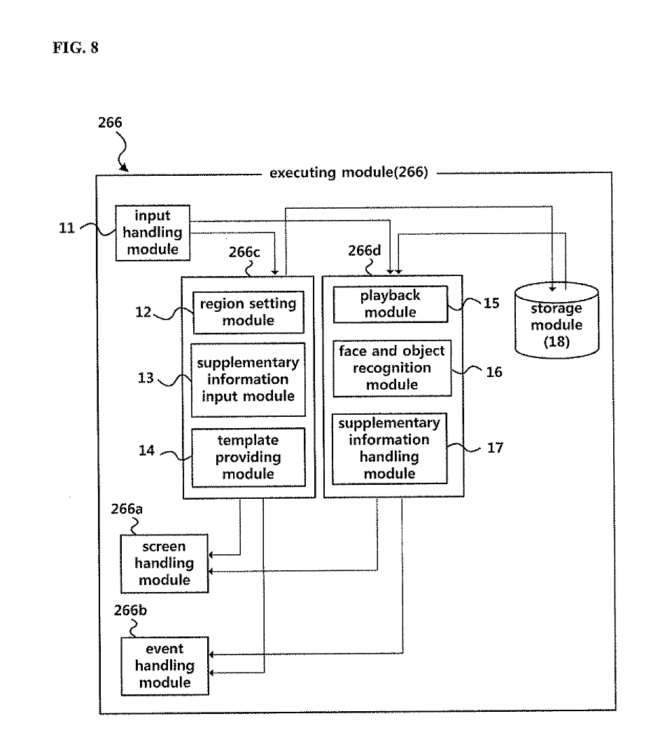

FIG. 8 illustrates the configuration of an object-based content application running on the stationary computer 200.

The object-based content application may be executed by the executing module 266 in FIG. 3, and includes an object-based content authoring tool 266c and an object-based content player 266d.

As described in connection with FIG. 3, when the user generates remote control signals using the smartphone, the requesting module 262 generates corresponding application events so that the target application is executed according to the analyzed control signals. In response to a request from the requesting module 262, an input handling module 11 generates a control signal corresponding to the request and feeds the control signal to the object-based content authoring tool 266c or the object-based content player 266d to initiate the application process. For example, when the user selects a region of content displayed on the screen of the smartphone by dragging operation, a corresponding signal is sent to the input handling module 11 of the executing module 266 through steps depicted in FIG. 6; the input handling module 11 identifies coordinates of the dragged region on the screen and notifies a region setting module 12 of the coordinates of the dragged region; and the region setting module 12 recognizes the dragged region as an object.

The object-based content authoring tool 266c is a module that is used to author object-based content according to remote control of the user of the smartphone.

The region setting module 12 performs object setting under control of the input handling module 11 by tracking and extracting a region associated with one or more objects appearing in displayed content. For example, when the user specifies a rectangular or circular region of a photograph displayed on the screen of the smartphone by dragging or the like, the region setting module 12 sets the specified region as an object region. In the case of a moving image, when the user specifies a rectangular or circular region of a current frame displayed on the screen of the smartphone, the region setting module 12 sets the specified region as an initial object region and performs object tracking by enabling the user to identify object movement and disappearance and change the location of the object region in subsequent frames.

A supplementary information input module 13 receives supplementary information of a tracked or extracted object and stores information on mapping between the object and the supplementary information in a storage module 18. Later, when the object is selected, the supplementary information mapped with the object is provided. When a person is specified as an object, the supplementary information may include a name, phone number, e-mail address and image capture date. When a product is specified as an object, the supplementary information may include a product name, manufacturer, specification, and website address for guiding purchase and making a purchase. When a geographical area is specified as an object, the supplementary information may include a place name, location and area-specific advertisements.

The supplementary information may be a content list linked with an external content providing apparatus. In this case, after selecting an object, the user may obtain additional content in a content list by further selecting the supplementary information mapped with the object. Content provided by the external content providing apparatus may take the form of image data, sound data or a combination of image and sound data. Supplementary information is preferably text data, and may also be other data such as template data provided by a template providing module 14 described below.

The template providing module 14 provides a template that enables the supplementary information to contain data of various formats in terms of font, color, size and pattern in addition to simple text. The authoring user may select one of various sample templates and enter the supplementary information using the selected template.

An object-based content player 266d is a module that plays back object-based content according to remote control of the user of the smartphone, and is a special purpose player for object-based video.

A playback module 15 decodes, under control of the input handling module 11, object-based content selected by the user among more than one object-based content stored in the storage module 18 using a suitable codec and plays back the decoded object-based content through a display module (not shown). The playback module 15 may include a decoder capable of decoding video files in various formats such as AVI, MPEG, MPEG2, MPEG4, WMV, H.264 and DIVX. The playback results are sent to the smartphone 100 through steps described in FIG. 6 so that the user may enjoy the content on the smartphone 100.

A face and object recognition module 16 may recognize, when an object appearing in the content being played back by the playback module 15 is a person, the face of the person to thereby automatically output supplementary information mapped with the person without user selection. When a person appearing in the played object-based content is mapped with supplementary information and information of the person such as contact and e-mail address is stored in the smartphone 100, the face and object recognition module 16 may request a supplementary information handling module 17 to output the stored information together with the supplementary information.

The face and object recognition module 16 may identify an object in a region selected by the user on the screen of the smartphone and automatically output supplementary information mapped with the identified object.

The supplementary information handling module 17 extracts supplementary information mapped with an object that is automatically recognized or is selected by the user, in response to a request from the face and object recognition module 16, and outputs the extracted supplementary information to the smartphone 100.

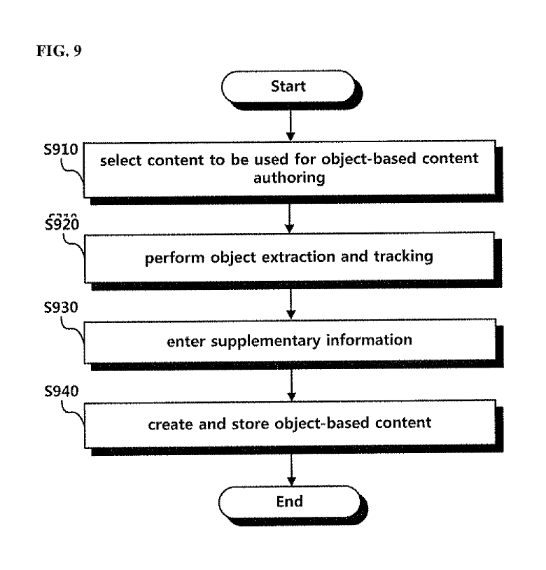

FIG. 9 is a flowchart of a procedure for authoring object-based content on the stationary computer 200 according to remote control using a smartphone 100.

Referring to FIG. 9, the object-based content authoring procedure includes: selecting content to be used for object-based content authoring (S910); extracting and tracking an object (S920); entering supplementary information (S930); and creating and storing object-based content (S940).

At step S910 of selecting content to be used for object-based content authoring, content to be used for object-based content authoring is selected among multiple content including photographs and moving images stored in the stationary computer 200 according to remote control of the smartphone 100.

Although the authoring procedure is described as starting with selection of content stored in the stationary computer 200, the user may send content to be used from the smartphone 100 to the stationary computer 200 first and then initiate the authoring procedure.

At step S920 of extracting and tracking an object, an object appearing in the content to be used for authoring is extracted and tracked using the object-based content authoring tool 266c according to user manipulation. To achieve this, the object-based content authoring tool 266c includes a region setting module 12 and a supplementary information input module 13 and may further include a template providing module 14 as shown in FIG. 8. As described in connection with FIG. 8, the region setting module 12 extracts and tracks an object appearing in content on the object-based content authoring tool according to user manipulation.

At step S930 of entering supplementary information, supplementary information of an extracted object is entered. The supplementary information input module may receive supplementary information as text entered by the user or receive supplementary information by selecting a template provided by the template providing module.

At step S940 of creating and storing object-based content, object-based content is created by associating the extracted and tracked object with the entered supplementary information and the created object-based content is stored. The region setting module 12 and the supplementary information input module 13 create object-based content through steps S910, S920, S930 and S940 and store the created object-based content in the storage module. As a result, object-based content may include a moving image from which an object is extracted and tracked and supplementary information linked with the object.

Next, the above procedure is described in more detail with reference to signal flows between component modules.

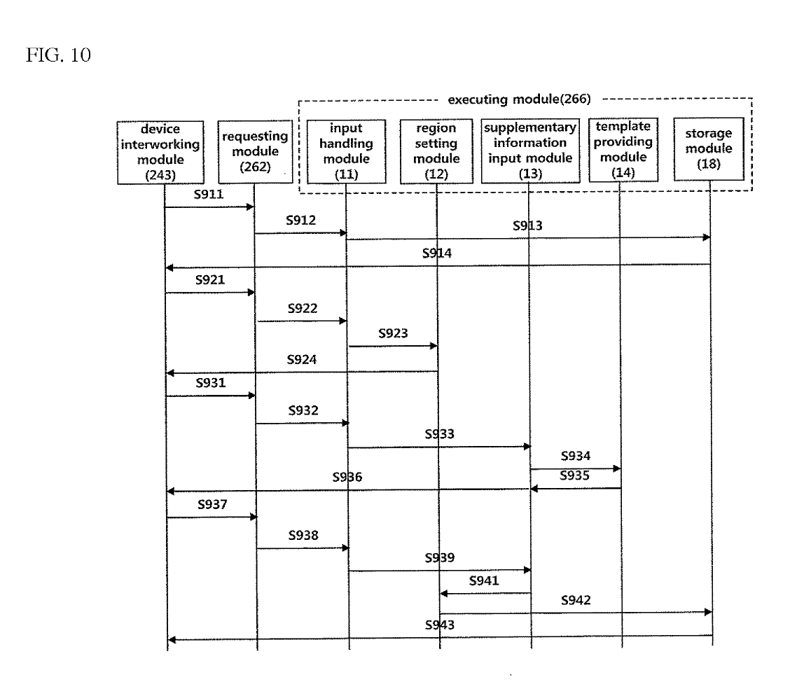

FIG. 10 is a sequence diagram illustrating signal flows between components carrying out the procedure for authoring object-based content in FIG. 9.

The procedure of FIG. 10 corresponds to the right end part of the procedure of FIG. 6 in which an application on the stationary computer 200 is controlled by control signals sent by the stationary computer 200.

That is, step S640 (analyzing control signals) in FIG. 6 is associated with steps S911, S921, S931 and S937 (analyzing control signals) in FIG. 10; step S650 (determining input events and applying them to application process) is associated with steps S912, S922, S932 and S938 (applying events to application process); and step S660 (outputting application results) is associated with steps S914, S924, S936 and S943 (outputting various results from the executing module 266). Hence, steps S610 to S631 of FIG. 6 are performed before each of steps S911, S921, S931 and S937 of FIG. 10; and steps from S661 to the last (outputting application screens) of FIG. 6 are performed after each of steps S914, S924, S936 and S943.

Referring to FIG. 10, when the user of the smartphone 100 sends a control signal for selecting desired content stored in the stationary computer 200, the control signal is delivered through the device interworking module 243 and the requesting module 262 of the stationary computer 200 to the input handling module 11 of the executing module 266 (S911 and S912). The input handling module 11 reads the selected content from the storage module 18 (S913), and forwards the content to the device interworking module 243 (S914). Thereafter, the content may be sent to the smartphone 100 and be played back for the user.

When the user of the smartphone 100 specifies an object region of the content to be mapped with supplementary information, the control signal specifying the object region is delivered through the device interworking module 243 and the requesting module 262 to the input handling module 11 of the executing module 266 (S921 and S922). The input handling module 11 forwards the control signal to the region setting module 12 (S923).

As described before in connection with FIG. 8, the region setting module 12 performs object setting under control of the input handling module 11 by extracting and tracking a region associated with one or more objects appearing in the content. For example, when the user specifies a rectangular or circular region of a photograph displayed on the screen of the smartphone by dragging or the like, the region setting module 12 sets the specified region as an object region. In the case of a moving image, when the user specifies a rectangular or circular region of a current frame displayed on the screen of the smartphone, the region setting module 12 sets the specified region as an initial object region and performs object tracking by enabling the user to identify object movement and disappearance and change the location of the object region in subsequent frames. The results of object region setting and tracking are output to the device interworking module 243 (S924). The output results are sent to the smartphone 100 and are displayed to the user.

When the user requests to enter supplementary information to be mapped with the specified object through the smartphone 100, the control signal for entering supplementary information is delivered through the device interworking module 243 and the requesting module 262 to the input handling module 11 of the executing module 266 (S931 and S932). The input handling module 11 forwards the control signal for entering supplementary information to the supplementary information input module 13 (S933). When the user enters supplementary information in text, entering of the supplementary information may be directly performed (S937, S938 and S939). When the user requests a template of a specific type, the supplementary information input module 13 may output a sample template obtained from the template providing module 14 to the user (S935 and S936). As described before, the template providing module 14 provides a template that enables the supplementary information to contain data of various formats in terms of font, color, size and pattern in addition to simple text. The user may select one of various templates and enter supplementary information using the selected template (S937, S938 and S939).

When the user finishes entering supplementary information, the entered supplementary information is delivered to the region setting module 12 (S941). The region setting module 12 creates object-based content by associating the specified object region with the entered supplementary information and stores the object-based content in the storage module 18 (S942). Thereafter, a notification indicating completion of object-based content creation is sent to the smartphone 100 (S943).

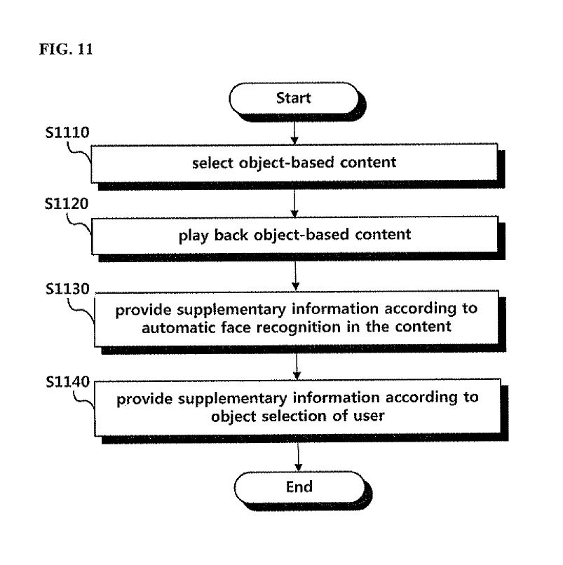

FIG. 11 is a flowchart of a procedure for utilizing object-based content on the stationary computer according to remote control using a smartphone.

Referring to FIG. 11, the procedure for utilizing object-based content includes: selecting object-based content (S1110); playing back the object-based content (S1120); providing supplementary information according to automatic face recognition in the content (S1130); and providing supplementary information according to object selection of the user (S1140).

More specifically, at step S1110 of selecting object-based content, the user of the smartphone 100 selects desired object-based content stored in the stationary computer 200.

At step S1120 of playing back the object-based content, the selected object-based content is played back on the stationary computer 200. The playback outputs are sent to the smartphone 100 and the user may view the content on the smartphone 100.

At step S1130 of providing supplementary information according to automatic face recognition in the content, the face and object recognition module 16 of the executing module 266 recognizes the face of a person appearing in the object-based content and provides the supplementary information mapped with the person to the smartphone 100. Step S1130 for automatic face recognition is an optional step, and may be excluded from the procedure.

At step S1140 of providing supplementary information according to object selection of the user, the user specifies an object region of the object-based content on the screen of the smartphone 100, and then the executing module 266 provides the supplementary information mapped with the corresponding object to the smartphone 100.

According to the steps described above, the user of a smartphone may view object-based content and receive related supplementary information using the smartphone.

Next, the above procedure is described in more detail with reference to signal flows between component modules.

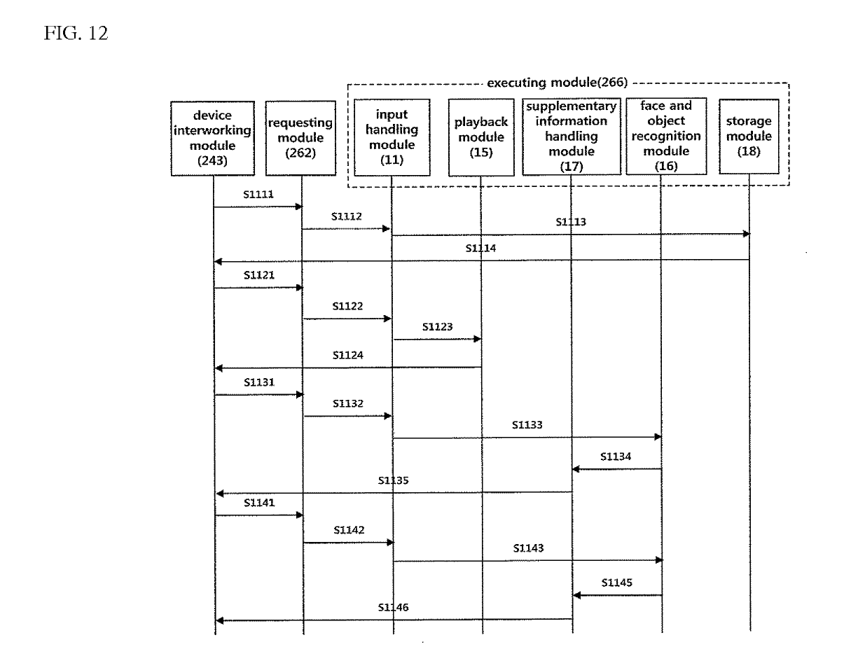

FIG. 12 is a sequence diagram illustrating signal flows between components carrying out the procedure for utilizing object-based content of FIG. 11.

As in FIG. 10, the procedure of FIG. 12 corresponds to the right end part of the procedure of FIG. 6 in which an application on the stationary computer 200 is controlled by control signals sent by the stationary computer 200.

That is, step S640 (analyzing control signals) in FIG. 6 is associated with steps S1111, S1121, S1131 and S1141 (analyzing control signals) in FIG. 12; step S650 (determining input events and applying them to application process) is associated with steps S1112, S1122, S1132 and S1142 (applying events to application process); and step S660 (outputting application results) is associated with steps S1114, S1124, S1135 and S1146 (outputting various results from the executing module 266). Hence, steps S610 to S631 of FIG. 6 are performed before each of steps S1111, S1121, S1131 and S1141 of FIG. 12; and steps from S661 to the last (outputting application screens) of FIG. 6 are performed after each of steps S1114, S1124, S1135 and S1146.

Referring to FIG. 12, when the user of the smartphone 100 sends a control signal for requesting an object-based content list to the stationary computer 200, the control signal is delivered through the device interworking module 243 and the requesting module 262 to the input handling module 11 of the executing module 266 (S1111 and S1112). The input handling module 11 reads an object-based content list from the storage module 18 (S1113), and forwards the object-based content list to the device interworking module 243 (S1114). Thereafter, the object-based content list is sent to the smartphone 100 and is displayed to the user.

When the user of the smartphone 100 selects object-based content from the list and requests playback of the selected object-based content, the control signal requesting playback of the object-based content is delivered through the device interworking module 243 and the requesting module 262 of the stationary computer 200 to the input handling module 11 of the executing module 266 (S1121 and S1122). The input handling module 11 forwards the control signal to the playback module 15 (S1123). The playback module 15 plays back the requested object-based content on the stationary computer 200 and the playback outputs are sent to the stationary computer 200 (S1124). The user may view the outputs of the played back object-based content using the smartphone 100.

When the user of the smartphone 100 requests supplementary information of a person (object) appearing in the object-based content (S1131 and S1132), the face and object recognition module 16 of the executing module 266 recognizes the face of the person and sends object information of the person to the supplementary information handling module 17 (S1134). The supplementary information handling module 17 extracts supplementary information mapped with the object and sends the supplementary information to the smartphone 100 (S1135).

As an example of providing supplementary information according to automatic face recognition, the face and object recognition module 16 recognizes the face of a specified person, checks whether contact information of the person is stored in the storage module 18, and extracts, when contact information of the person is stored, the contact information and provides the extracted contact information to the smartphone 100. Here, contact information of a person may include a phone number and e-mail address of the person.

The face and object recognition module 16 may add extracted contact information to the supplementary information mapped with a person (object). For example, when supplementary information mapped with a person is not present (null), the face and object recognition module 16 may find contact information of the person in the storage module 18 and set the contact information as supplementary information mapped with the person.

Providing supplementary information according to automatic face recognition is an optional step, and may be excluded from the procedure.

Supplementary information may be provided according to object selection of the user. The user specifies an object region of the object-based content on the screen of the smartphone 100, and then the executing module 266 provides the supplementary information mapped with the corresponding object to the smartphone 100.

That is, when the user directly selects an object region of the object-based content on the screen of the smartphone 100, the control signal specifying the object region is delivered to the input handling module 11 (S1141 and S1142). The input handling module 11 sends information on the specified object region to the face and object recognition module 16 (S1143). The user may select an object region by specifying a rectangular or circular region of the content on the screen of the smartphone through dragging or the like. The face and object recognition module 16 identifies an object corresponding to the object region and sends information on the object to the supplementary information handling module 17 (S1145). The supplementary information handling module 17 extracts supplementary information mapped with the object and sends the supplementary information to the smartphone 100 (S1146). The supplementary information of the selected object is displayed on the screen of the smartphone 100 during content playback.

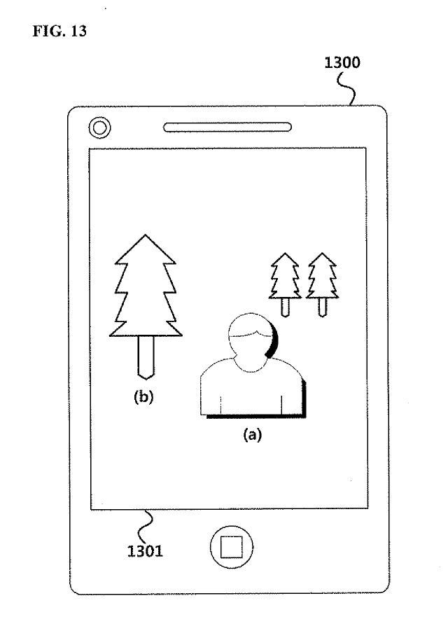

FIGS. 13 to 15 are screen representations depicting operation of an object-based content providing apparatus for a mobile terminal.

As shown in FIG. 13, the smartphone 100 described before may act as the object-based content providing apparatus for a mobile terminal. The screen 1301 may be a playback screen of regular content being used as a basis for object-based content authoring or be a playback screen of existing object-based content. The regular content or the object-based content is played back on the stationary computer 200 and screen data is delivered to the smartphone 100.

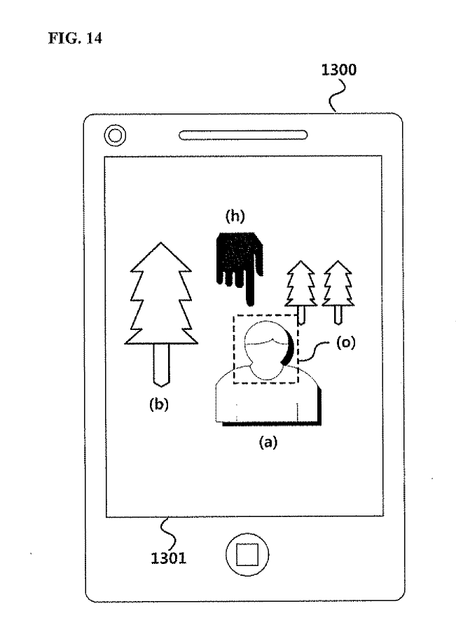

The screen of FIG. 14 may be an authoring screen for object-based content or a playback screen of existing object-based content.

For object-based content authoring, the user specifies a region (o) corresponding to a person (a) or object (b) appearing in the content by making a touch gesture with the hand (h) on the touchscreen of a display module 1301. When the content is a moving image (not shown), the user specifies a person (a) or object (b) in subsequent frames. When the user enters supplementary information after specifying an object, the executing module 266 of the stationary computer 200 creates object-based content by associating the object with the supplementary information.

For playback of existing object-based content, when the user specifies a region, the executing module 266 of the stationary computer 200 provides supplementary information mapped with an object corresponding to the region to the user.

For a person, a region (o) corresponding to the face may be automatically specified by the face and object recognition module 16 without explicit user manipulation and supplementary information mapped to the person may be provided.

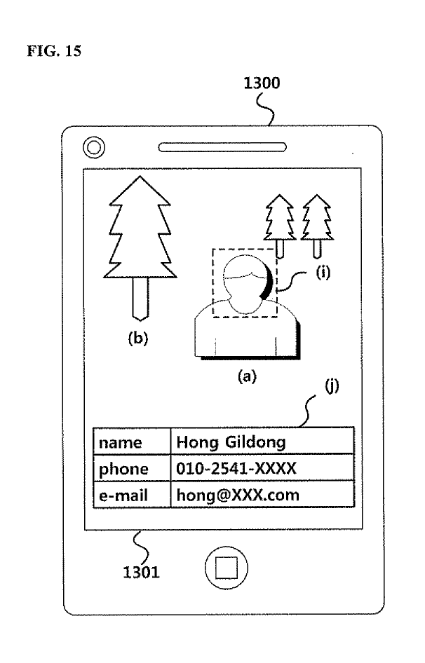

The screen of FIG. 15 may be an authoring screen for object-based content or a playback screen of existing object-based content.

For object-based content authoring, after specifying a region (i) (object selection), the user enters supplementary information (j) on the touchscreen of the display module 1301. Here, supplementary information may be entered in a sample template provided by the template providing module. For a person (a), the supplementary information preferably includes at least a name and phone number. Thereby, object-based content may be created by associating the person with the supplementary information.

For playback of existing object-based content, when the user specifies a region (i), supplementary information (j) mapped with an object corresponding to the region (i) is displayed on the playback screen.

For a person, a region (i) corresponding to the face may be automatically specified by the face and object recognition module 16 without explicit user manipulation and supplementary information (j) mapped with the person may be provided.

The remote control method using a smartphone may be implemented using computer programs and may be stored in computer-readable storage media such as a CD-ROM, RAM, ROM, floppy disk, hard disk and magneto-optical disk.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

1. A method for remotely controlling a stationary computer using a smartphone, comprising:
accepting manipulation results of a user and sensing results of sensors;
generating a control signal for an application running on the stationary computer through filtering and optimizing the accepted results;
transmitting the control signal to the stationary computer; and
receiving a response signal of the application from the stationary computer.

2. The method of claim 1, further comprising:
connecting to, before accepting user manipulation results, the stationary computer via a wired or wireless network; and
executing a sub-application interworking with the application.

3. The method of claim 1, wherein generating a control signal for an application comprises:
extracting a portion of the user manipulation results and sensing results related to the application; and
generating the control signal by converting the extracted portion into a signal for transmission through compression.

4. The method of claim 1, further comprising:
analyzing, after receiving a response signal, the response signal; and
reproducing an application screen, sound and vibration according to the analysis results.

5. The method of claim 1, wherein the sensing results are related to sound and brightness around the user, and location and placement state of the smartphone.

6. The method of claim 1, wherein the application is an application for authoring object-based content by providing supplementary information to an object appearing in played back content of moving images or photographs, wherein the user is an author who authors object-based content on the basis of regular image content by remotely controlling the authoring application using the smartphone, wherein the control signal is a signal that is generated by the smartphone for controlling an object-based content authoring process according to user input, and wherein the response signal is a signal that is generated by the authoring application in progress and is sent to the smartphone.

7. The method of claim 1, wherein the application is an application that plays back object-based content and provides supplementary information of an object appearing in the object-based content, wherein the user enjoys the object-based content and views supplementary information of an object appearing in the object-based content by remotely controlling the application using the smartphone, wherein the control signal is a signal that is generated by the smartphone according to user inputs to control a process of playback of the object-based content and providing supplementary information, and wherein the response signal is a signal that is generated by the application in a process of playing back the object-based content and providing supplementary information and is sent to the smartphone.

8. A method for application execution on a stationary computer according to remote control of a smartphone, comprising:
receiving a control signal for an application in execution from the smartphone and analyzing the received control signal;
determining an event corresponding to the analyzed control signal and applying the event to a process of the application;
generating a response signal by converting and optimizing output results of the application process; and
transmitting the response signal to the smartphone.

9. The method of claim 8, further comprising:
receiving, before receiving a control signal, a connection request from the smartphone via a wired or wireless network; and
executing a main application interworking with the application.

10. The method of claim 8, wherein generating a response signal comprises:
processing output results of the application into a form reproducible by the smartphone with reference to existing setting information; and
generating the response signal by converting the processed output results into a signal for transmission through compression.

11. The method of claim 10, wherein the setting information comprises data related to display resolution and video codecs of the smartphone.

12. The method of claim 8, wherein the application is an application for authoring object-based content by providing supplementary information to an object appearing in played back content of moving images or photographs, wherein the control signal is a signal that is generated by the smartphone for controlling an object-based content authoring process according to user input, and wherein the response signal is a signal that is generated by the authoring application in progress and is sent to the smartphone.

13. The method of claim 8, wherein the application is an application that plays back object-based content and provides supplementary information of an object appearing in the object-based content, wherein the control signal is a signal that is generated by the smartphone according to user inputs to control a process of playback of the object-based content and providing supplementary information, and wherein the response signal is a signal that is generated by the application in a process of playback of the object-based content and providing supplementary information and is sent to the smartphone.

14. A remote control apparatus comprising a smartphone and a stationary computer,
wherein the smartphone comprises:
an input/output unit accepting manipulation results of a user and sensing results of sensors;
a remote control unit generating a control signal for an application running on the stationary computer through filtering and optimizing the accepted results; and
a terminal transceiver unit transmitting the control signal to the stationary computer and receiving a response signal of the application from the stationary computer, and
wherein the stationary computer comprises:
a remote input/output unit analyzing the control signal and generating the response signal by converting and optimizing output results of the application;
an application activation unit determining an event corresponding to the control signal analyzed by the remote input/output unit, applying the event to a process of the application, and providing output results of the application to the remote input/output unit; and
a computer transceiver unit receiving the control signal and transmitting the response signal to the smartphone.

15. The remote control apparatus of claim 14, wherein the input/output unit comprises:
an input module having at least one of a qwerty keypad, touchscreen, optical track mouse, camera module, microphone module, GPS module, tilt sensor and ambient light sensor; and
an output module having at least one of a display module, speaker module and vibration module.

16. The remote control apparatus of claim 14, wherein the remote control unit comprises:
a filtering and optimization module extracting a portion of the manipulation results and sensing results related to the application and generating the control signal by converting the extracted portion into a signal for transmission through compression; and
a response analysis module analyzing the response signal and providing the analysis results to the input/output unit.

17. The remote control apparatus of claim 14, wherein the remote input/output unit comprises:
a device interworking module analyzing the control signal and generating the response signal by converting and optimizing output results of the application; and
a function setting module providing setting information containing data related to display resolution and video codecs of the smartphone to the device interworking module generating the response signal.

18. The remote control apparatus of claim 14, wherein the application activation unit comprises:
a requesting module determining an event for keys, coordinates or sensing results corresponding to the control signal analyzed by the remote input/output unit and applying the event to a process of the application; and
an executing module outputting results of the application process in progress.

19. The remote control apparatus of claim 14, wherein the application activation unit comprises an object-based content authoring tool that authors object-based content according to remote control of the user utilizing the smartphone.

20. The remote control apparatus of claim 14, wherein the application activation unit comprises an object-based content player that plays back object-based content according to remote control of the user utilizing the smartphone.
